(19) United States
(12) Patent Application Publication
(10) Pub. No.: US 2022/0317749 A1
(43) Pub. Date: Oct. 6, 2022

(54) METHOD AND APPARATUS FOR LOW LEVEL UTILIZATION OF EXCESS POWER WITHIN A DATA CENTER

(71) Applicant: Intel Corporation, Santa Clara, CA (US)

(72) Inventors: Francesc GUIM BERNAT, Barcelona (ES); Karthik KUMAR, Chandler, AZ (US); Marcos E. CARRANZA, Portland, OR (US); Cesar Ignacio MARTINEZ SPESSOT, Hillsboro, OR (US); Trevor COOPER, Portland, OR (US)

(21) Appl. No.: 17/848,387

(22) Filed: Jun. 23, 2022

(51) Int. Cl. G06F 1/26

(52) U.S. Cl. CPC G06F 1/26

(57) ABSTRACT

A method is described. The method includes performing the following within a data center: a) recognizing that excess power derived from one or more ambient sources is available; b) determining allocations of respective portions of the excess power for different units of hardware within the data center; c) determining respective higher performance and higher power operational states for certain functional blocks within the different units of the hardware to utilize the excess power.

### BACKGROUND

Modern data centers are becoming increasingly carbon footprint conscious as their electronic systems (racks of computers and network switches) are continually consuming more electrical power with the corresponding continual increase in their performance. As such, modern data centers are looking to increase their dependence on electricity generated from ambient power sources such as solar power and wind power.

### FIGURES

FIG. 1 shows a data center that uses electrical power generated from ambient sources;

FIG. 2 shows a system for distributing excess power to specific hardware components within a data center;

FIG. 3 shows a methodology of the system of FIG. 2;

FIG. 4 shows exemplary information maintained by an LPDU of the system of FIG. 2;

FIGS. 5a and 5b show a tiered memory system that can be implemented with the system of FIG. 2;

FIG. 6 shows an electronic system;

FIG. 7 shows a data center;

FIG. 8 shows a rack.

### DETAILED DESCRIPTION

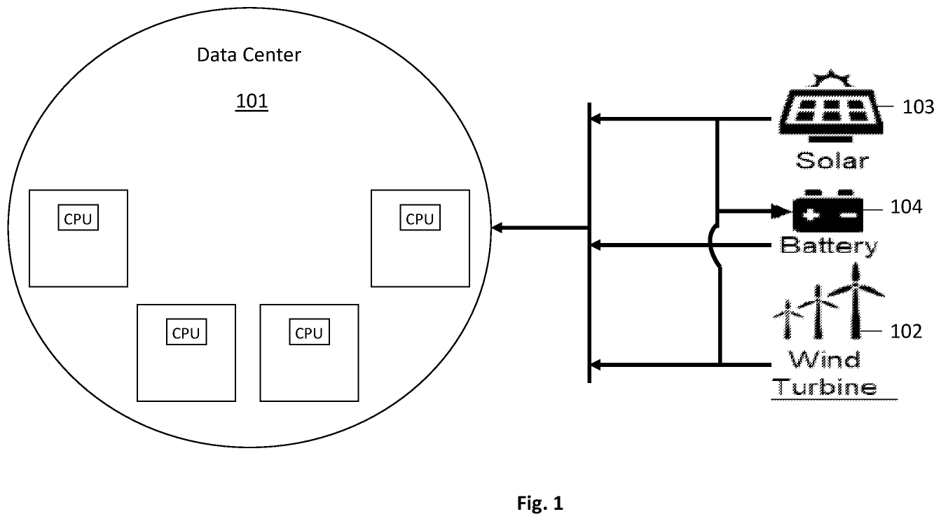

FIG. 1 shows a high level view of a data center 101 that has been designed to consume electrical power generated from ambient sources. Specifically, the data center 101 is coupled to receive electrical power generated from both wind turbine 102 and solar panel 103 infrastructure (wind turbines generate electrical power from wind and solar panels generate electrical power from sunlight). Notably, high capacity energy storage devices 104 (e.g., large scale capacitors, batteries, etc.) are coupled to the wind turbine 102 and solar panel 103 infrastructure to store the power that the infrastructure generates.

Here, for example, during times of the day when either or both sources of ambient power are active (e.g., during moments of high wind for the wind turbine 102 and moments of intense sunlight for the solar panels 103), the energy generated from either source is stored in the storage devices 104. The energy stored in the storage devices is released and fed to the data center 101 to power the data center. Generally, the storage devices 104 are periodically charged while the ambient power is being generated and periodically bled of energy as the data center 101 consumes power.

Notably, there can exist situations where the ambient power is generated at such a high rate that excess power remains after the storage devices have been fully replenished and the data center 101 is operating normally and being fed with all the power it needs. Such a situation, which can present a form of excess grid feed in, nominally results in wasted power (the excess power is not used) if the data center 101 continues to operate normally. That is, there is no additional storage capacity to store the excess power and the data center 101 is not consuming the excess power. As such, the excess power is simply lost.

A better approach is to use the excess power by ramping up the activity of the data center 101. To date data centers have only modulated data center activity as a function of excess power only at a high, application software level. For example, additional application software programs are instantiated and executed when moments of excess power are observed.

Unfortunately, there is a realm of lower level, more hardware centric functions that could make use of the excess power but are not capable of doing so because there is no mechanism to communicate to the lower firmware/hardware levels of the data center's computing and networking equipment that excess power exists. Here, nominally, the highest performance functions of the hardware are only intermittently performed, e.g., according to some schedule or when runtime conditions warrant, because of the excess power such functions consume.

That is, for example, the low level firmware and/or hardware is designed to perform these functions, e.g., only when necessary, because of the greater amount of power such functions consume even though the performance of the equipment would benefit if these functions were performed more regularly.

An example is active eviction of dirty cache lines in a CPU's cache hierarchy. Here, during nominal runtime, a line of data in a cache slot can contain updated data that is to be written back to main memory (such lines of data are referred to as “dirty” cache lines). A CPU cache hierarchy is nominally designed to evict a dirty cache line to a lower level cache or to main memory when a different cache line competes for the slot that the dirty cache line is stored in.

As a consequence, the presence of the dirty cache line must first be detected and then read from the slot before the competing cache line is stored in the slot. The activity of detecting the dirty cache line and then reading it from the slot impacts the performance of the cache (the competing cache line must wait before it can be written into the slot).

A better approach would be to continually scroll through the cache, detect its dirty cache lines and write the dirty cache lines back to main memory, e.g., as a continual background process. Once the dirty cache lines are written back to main memory they are no longer dirty (their content is consistent with the content of main memory) and can be directly written over by a competing cache line thereby improving the cache's performance.

However, because a continual background process would cause the corresponding computer system to consume larger amounts of power, it is not performed during nominal data center operation.

By contrast, if the computer system's firmware and/or hardware was made aware of the existence of the excess power, it could enter a higher power mode that performs the continual background process thereby improving the performance of the computer system without increasing its carbon footprint (because the source of the excess power, e.g., wind or sunlight, is carbon emission free).

A multitude of other high performance low level firmware/hardware centric functions could be considered for operation if the low level firmware/hardware, and/or the higher level control functions that configure them, were made aware of the existence of excess power when it becomes available.

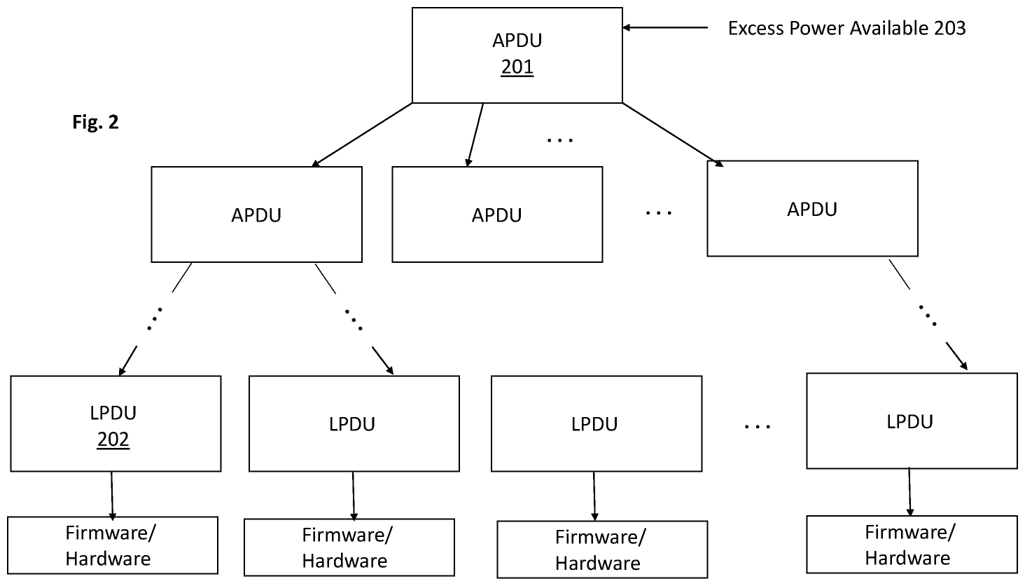

FIG. 2 shows an architecture for a data center control function that causes certain hardware components within the data center to be placed in a higher performance state when the control function becomes aware that excess power exists. The higher power consumption of these components when placed in the higher performance state consumes the excess power resulting in little/no wasted power.

As observed in FIG. 2, one or more aggregate power distribution units (APDUs) 201 receive information, e.g., from “green” power providers, concerning the current existence of any excess ambient power, and, to the extent possible, how long such excess ambient power is expected to last. The APDU(s) 201 can be integrated within the infrastructure of power utility companies, the data center or some combination of both.

As suggested in FIG. 2, a hierarchy of APDUs 201 can be established with the APDU(s) that are higher in the architecture being closer to the ambient power providers and the APDU(s) that are lower in the architecture being closer to the hardware and firmware of the data center's computing and networking equipment. Such lower APDU(s), in various embodiments, are communicatively coupled to multiple local power distribution units (LPDUs) 202. Each LPDU 202 controls the power/performance settings of specific set of hardware components within the data center that the LPDU is dedicated to (for ease of drawing FIG. 2 only labels one APDU and one LPDU with a reference number).

The granularity of the LPDUs 202 can vary from embodiment. For example, according to a first approach, an LPDU is dedicated to a specific high density, high performance semiconductor chip (e.g., a system on chip (SoC) having multiple general purpose or special purpose processing cores). That is, certain SoCs within the computing and/or networking hardware of the data center have an associated LPDU that controls the power/performance settings of the different functional blocks within the SoC (e.g., the power/performance settings of the CPU cores, memory controller, cache hierarchy between the CPU cores and the memory controller, accelerator(s) integrated on the SoC (if any), peripheral control hub and certain peripherals that are coupled to the SoC (e.g., solid state drive(s) (SSD(s)). Here, the LPDU can be a component of the SoC's firmware and/or the firmware of the electronic system (e.g., computer, networking switch, module, etc.) that the SoC is integrated within. In the case of the later such firmware can be the system's basic input/output system (BIOS), Unified Extensible Firmware Interface (UEFI) and/or bootloader firmware.

At another lever of granularity an LPDU can be dedicated to an electronic system such as a server computer and/or networking switch. In this case, the LPDU controls power/performance settings of multiple high performance logic chips within the computer/switch. For example, in the case of a server computer having multiple CPU SoCs, the LPDU for the server controls the power/performance settings of the different functional blocks within each of the SoCs. Again, the LPDU can be the firmware of the electronic system (e.g., BIOS, UEFI, boot-loader, etc.).

At yet another level of granularity an LPDU corresponds to multiple electronic systems such as a rack of, e.g., 1U or 2U server computers and/or network switches. In this case, the LPDU establishes performance/power settings of each of the systems (each system then translates its configuration setting into specific settings of specific functional blocks within its internal SoCs).

As observed in FIG. 2, a single ADPU 201 can be communicatively coupled to multiple LPDUs 202 that reside beneath the ADPU 201 within the architecture. Notably, LPDUs 202 of differing granular level (e.g., SoC, server computer, rack, etc.) can coexist in a same data center, and, a same ADPU 201 can be communicatively coupled to such LPDUs 202 of differing granular level. The multiple ADPUs 202 can be distributed within the data center and push power related information down to the respective subset of LPDUs 202 that reside beneath them.

The ADPUs 201 understand whether or not excess power is currently available and, if so, how much (and, ideally, for how long). Upon recognizing the current existence of excess power, the ADPUs 201 determine how much of the excess power is to be allocated to the LPDUs 202 beneath them. That is, within the hierarchy of APDUs 201 each higher APDU 201 in the hierarchy determines how much excess power is to be distributed to the APDUs 201 that are immediately beneath it in the hierarchy and communicates the amounts to them. The lowest APDUs 201 in the hierarchy determine how much of the excess power is to be allocated to each of the LPDUs 202 beneath them and communicates the amounts to them.

When the LPDUs 202 are informed of the amount of excess power that has been allocated for the hardware units they are responsible for, the LPDUs 201 determine which of the individual hardware components/blocks they control are to be configured into a higher performance/power state and what specific states are to be entered. Each LPDU 202 aims to establish higher performance/power states for the hardware it controls that consume the excess power that has been allocated to the LPDU's 202 hardware.

In various embodiments, one or more APDUs and/or LPDUs, and/or their respective functions, are integrated within specific application software instances that execute on the data center computing resources thereby making the application software instances aware of the availability of excess power. The application software instances can then reconfigure themselves to make use the excess power (e.g., instantiate more CPU threads to speed-up their respective execution). The application software instances can have some primary purpose other than acting as an APDU or LPDU such as database software, various compute logic tasks (e.g., supply chain management, human resources (e.g., payroll), customer relationship management software, etc.). In other or combined implementations, APDUs and/or LPDUs stand alone as separate instances of application software.

Various alternative APDU/LPDU architectures to the specific architecture of FIG. 2 are possible. For example, there can be one APDU 201 per data center that communicates, e.g., with all LPDUs 202 in the data center. Alternatively, APDUs 201 can be distributed as peers that together execute a common protocol to determine how much excess power is distributed to each ADPU 201. Combinations of these two approaches are also possible.

As observed in FIG. 2 the ADPUs 201 are informed 203, e.g., by utility companies or other power providers, of the existence of excess power when such excess power materializes. Ideally, the power providers can also speculate as to how long such excess power is expected to exist and communicate it to the ADPUs 201. If the power provides do not give a time assessment, the ADPUs 201 can tap into integrated artificial intelligence (AI) machine learning technology within the data center and, over time, learn how to accurately predict excess power amount and duration.

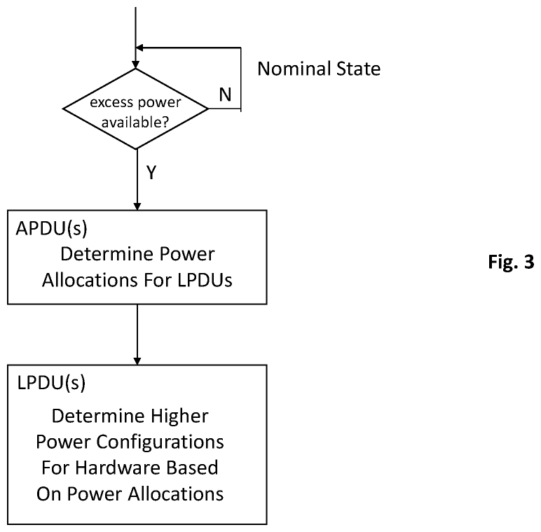

FIG. 3 shows a basic process that can be performed within a data center having the APDU and LPDU components described just above. As observed in FIG. 3, the APDUs receive information describing the state of the ambient power sources that the data center can draw from. In a nominal state, there is no excess power. In this state, the storage capacity is continually being depleted and recharged by the ambient power source(s) without an appreciable amount of ambient power being wasted or unused.

In the nominal state, typically, the hardware and/or firmware of the data center's computing and networking components are configured at less than full performance to ensure that their power consumption remains within the overall power budget that is established for the data center (which, e.g., depends upon some minimal amount of ambient power). For example, for a data center that relies upon solar power, the performance configurations of the data center's equipment are configured so that they will not completely drain the storage devices over the course of a nighttime.

At some point, however, excess power will exist (the storage devices remain substantially charged and there is appreciable leftover ambient power that is ready for immediate use). The APDU(s) are informed of the excess power and determine 301 allocations of the excess power across the various LPDUs within the system. The LPDUs are then informed of their respective power allocations. In response, each LPDU determines 302 an appropriate, new configuration for the underlying hardware that it controls. Here, the new configuration setting steps up the performance of the hardware. Importantly, the step up in performance is designed to consume the excess power that has been assigned to the LPDU without exceeding it or appreciably under consuming it.

The reconfigured hardware then operates at the higher performance level and corresponding power consumption. Ideally, there exists some understanding of how long the excess power state will last (e.g., based on sunlight and/or weather conditions). Such information is communicated from the APDUs to the LPDUs which can schedule their underlying hardware components to operate at the higher performance/power level only for as long as the excess power is expected to last.

Upon the excess power state nearing or reaching an end, the LPDUs reconfigure their underlying hardware to their nominal configuration at which point the data center returns to its nominal performance and power consumption state. Here, some hysteresis can be built into the initial decision as to whether sufficient excess power exists to trigger higher performance/power consumption states and whether the excess power has sufficiently fallen to trigger fall-back to nominal (lower performance/power consumption) operational states. According to one approach, in order to ensure battery power is not wasted by operating at higher performance/power states when excess power is minimal, fall-back to the lower performance/power states is triggered when the excess power falls below some appreciable level. As such, triggering into a higher performance/power state requires the excess power to reach a level that is significantly above this level (e.g., to prevent thrashing between high/low performance/power states).

In various embodiments, each LPDU maintains information describing the different higher performance configurations that its underlying hardware can implement and their associated power consumption levels. From this information, the LPDU chooses a particular one or more of these configurations in view of the excess power that has been allocated to it.

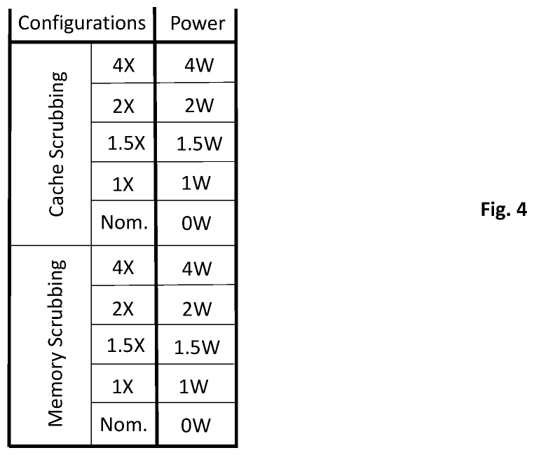

FIG. 4 shows an exemplary embodiment of such information. Here, higher performance functions for a multi-core processor SoC are listed. A first higher performance function corresponds to the aforementioned cache scrubbing process (in which dirty cache lines are proactively written back to main memory) and a second higher performance function corresponds to a similar, main memory scrubbing process (in which dirty pages of data in main memory are proactively written back to non-volatile mass storage).

Note that different higher performance functions can be performed by different components of the SoC (the first is performed by the CPU cache hierarchy logic while the second is performed by the main memory controller). Moreover, the different higher performance functions can be scaled to different degrees of increased performance and corresponding power consumption. Here, “nominal” corresponds to the performance and power consumption of the function in its nominal configuration (without excess power). Notably, in the exemplary information of FIG. 4, neither of the scrubbing functions are performed in the nominal state (power consumption=0 meaning the functions is not performed).

By contrast, the 1×, 1.5×, 2×, 4× states correspond to increasing levels of performance of the function (with corresponding increasing levels of power consumption) that can be performed when excess power has been allocated to the SoC. Here, with both of the functions corresponding to some form of scrubbing in which the cache/memory contents are actively scrolled through, the increasing degrees of performance can correspond to, e.g., how frequently the cache/memory is fully scrolled through. For example, in a 4× configuration, in a same time window, the SoC will fully scroll through the cache/memory twice as many times as in a 2× configuration and four times more than in a 1× configuration.

As observed in FIG. 4, each configuration includes a corresponding power consumption where increasing performance corresponds to increasing power consumption. When the SoC's LPDU is allocated a specific amount of excess power, the LPDU selects a configuration for the SoC from amongst the configuration options listed in FIG. 4 that keeps the total power consumption within the allocated excess power. For example, if the SoC's LPDU is allocated 4 W of excess power, the LPDU has the option of selecting: 1) only the 4× configuration for the cache scrubbing; 2) only the 4× configuration for the memory scrubbing; or, 3) the 2× configuration for the cache scrubbing and the 2× configuration for the memory scrubbing.

Which one of these options is chosen can be based on a myriad of factors, all of which can be incorporated into some kind of logic that is integrated into the LPDU. For example, there can be performance metrics on the recent performance of the cache and memory that favors increasing the performance of one of the cache and memory over the other (in which case options 1) or 2) are chosen), hints provided by the application software that is currently executing on the SoC that prefers one of the cache scrubbing and memory scrubbing over the other, etc. If the LPDU's selection logic does not manifestly choose one of the cache scrubbing and memory scrubbing over the other, the selection choice falls to option 3) which assigns relatively equal performance boosts to both the cache and the memory.

If, by contrast, the LPDU has only 1 W of excess power to assign to the SoC, the LPDU is forced to choose between a 1× configuration for the cache scrubbing or a 1× configuration for the memory scrubbing.

It is pertinent to point out that there can be a myriad of different hardware blocks besides a cache hierarchy and memory controller that can have excess power functions listed in the information of FIG. 4 (these two examples were chosen for ease of explanation). In essence, any functional block of an SoC (or other high performance logic chip) that can execute at some higher performance level in moments of excess power can have its higher performance functions listed in the information of FIG. 4 (e.g., one or more accelerators, one or more sensors, one or more network interfaces, one or more processing cores, one or more peripheral interfaces, one or more switch cores, one or more networks on-a-chip, etc.). Any peripherals that are coupled to the SoC and whose configuration settings are controlled through the SoC (e.g., one or more solid state drives (SSDs), one or more dual in-line memory modules (DIMMs), etc.) can also have higher performance excess power functions listed in the information of FIG. 4.

It is also pertinent to point out that the configuration options of FIG. 4 are presented as tubular information (which can be realized, e.g., in memory and/or register space) for the sake of example. Configuration options can also be realized, e.g., through execution of equations written in software that, e.g., present power consumption of a block as an output for a particular configuration setting input applied to the block (e.g., performance state, clock speed, etc.).

An LPDU can be implemented entirely in hardware, firmware, or software or any combination of two or more of these. For instance, in the case where an LPDU is dedicated only to a particular SoC, the LPDU can be implemented as a dedicated circuitry on the SoC, firmware of the SoC, software that executes on a processing core of the SoC or any combination of two or more of these. By contrast, in the case where an LPDU is dedicated to an entire server computer, the LPDU can be implemented as software that executes on the server in combination with firmware and supporting hardware within the different high performance semiconductor chips within the server (e.g., multiple multi-core CPU processor chips). Firmware is distinguishable from software such as application software in that application software is higher level software that executes to put the hardware it executes upon to some use, whereas, firmware is lower level software that controls some specific element of hardware.

Likewise, the APDUs can be implemented in hardware, firmware or software or any combination of two or more of these. In cases where an APDU function resides entirely within a data center, the APDU is likely to be implemented at least partially if not wholly in application software that executes on a computer of the data center. By contrast, if the APDU is integrated within a utility company or other entity that provides ambient induced power to the data center, the APDU could include hardware and/or firmware of sensors or other components that monitor whether an excess power state exists or not.

Whereas the LPDU makes its configuration decisions based on low level information, by contrast, the APDUs can be presented with higher level information that drives the LPDU power allotment decisions made by the APDUs. For instance, the APDUs can be made aware of higher priority applications and which computers they execute upon, which customers are paying premium prices for the data center's services, time dependent workload patterns of the various application programs that execute within the data center, etc. A myriad of such higher level factors can be codified and presented to the APDUs which, like the LPDUs, process an internal logic function that determines how the excess power that has been allotted to the APDU is be divided amongst the APDUs and/or LPDUs beneath it in the hierarchy.

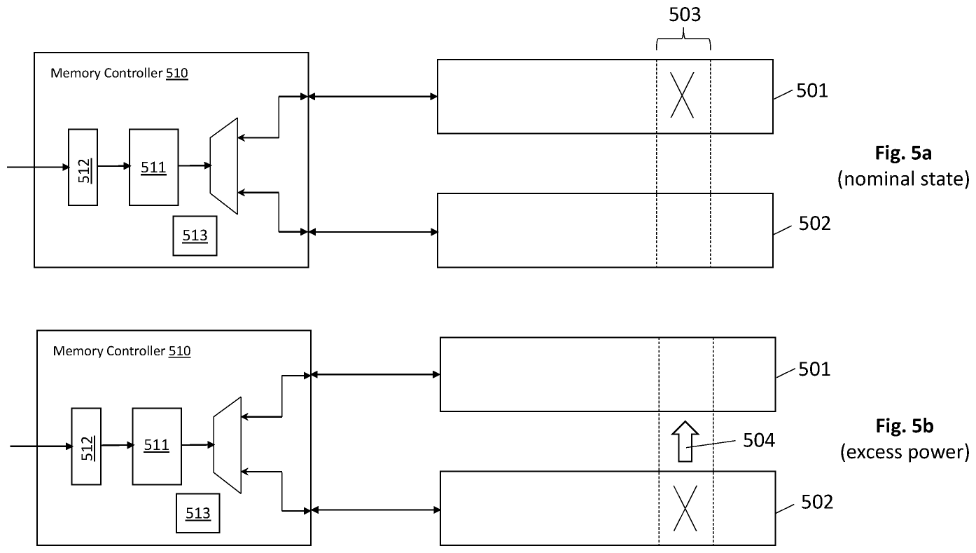

FIGS. 5a and 5b pertain to an enhancement that can be made to existing computing hardware to take advantage of the excess power allocation scheme described above.

FIG. 5a shows a multi-tier memory having a higher performance/power upper tier of memory 501 and a lower performance/power lower tier of memory 502. The upper tier of memory 501 can be composed of a different memory technology than the lower tier of memory 501 (e.g., the upper tier 501 is composed of dynamic random access memory (DRAM) whereas the lower tier 502 is composed of byte addressable, non volatile resistive cell memory (e.g., Optane memory from Intel Corporation). Alternatively the tiers 501, 502 can be composed of same memory technology but the upper tier 501 is clocked faster than the lower tier 502.

Regardless, as observed in FIG. 5a, in order to keep power usage in check during the nominal state, the second tier 502 is utilized but the upper tier 501 is not utilized (at least for one or more regions of the upper tier). More specifically, in the nominal state, an address range 503 in the lower tier 502 is utilized whereas a corresponding address range in the upper tier 501 is not utilized. Here, for example, an application software program could be allocated to use memory region 503 within the lower tier 502 during the nominal state. During the nominal state, there is a corresponding memory region 503 in the upper tier 501 that is not utilized (the memory is reduced to a low power state).

Referring to FIG. 5b, once excess power has been allocated to the memory system, the information within the memory region 503 of the second tier 502 is flushed up 504 into the corresponding region 503 of the upper tier 501. That is, once excess power has been allocated to the memory system, the memory system enters a higher performance and power consumption state in which the address range 503 in the lower tier 502 is not utilized and the corresponding address range 503 in the upper tier 501 is utilized.

The memory controller 510 that accesses the memory has integrated logic that can “switch” from the lower tier 502 to the upper tier 501 for a particular address range 503 upon a configuration setting made, e.g., by an LPDU. More specifically, the memory controller 510 includes: 1) a memory request buffer 511 whose output can be directed to either the lower tier 502 or the upper tier 501; 2) an address decoder 512 that can direct a memory request having a particular memory address to a correct location in either the lower or upper tier depending on whether the memory system is operating the nominal or excess power state; and, 3) flushing circuitry 513 to manage the flushing of information between tiers.

Here, referring to FIG. 5a, in the nominal state, the memory controller 510 operates akin to a typical memory controller in that, e.g., memory addresses specified in memory requests that map to address range 503 in the lower tier 502 are entered in the buffer 511 and are serviced from the lower tier 502 according to their respective addresses.

Once the excess power state is entered, however, the flushing logic 513 begins flushing the content of the lower tier 502 in the address range 503 into its corresponding space 503 in the upper tier 501. Likewise, the address decoder 512 decodes any requests whose memory addresses would nominally map to address space 503 in the lower tier 502 in the nominal state into re-mapped addresses that map to the corresponding address space 503 in the upper tier 501.

In an embodiment, the new mapping is not performed by the address decoder 512 until the memory request buffer 511 is empty and all content in the region 503 in the lower tier 502 has been flushed up to the upper tier 501. Once both these conditions are satisfied, the address decoder 512 begins to map memory requests that nominally target space 503 in the lower tier 502 to instead target space 503 in the upper tier 501. Before then, memory requests continue to be serviced from the lower tier 502.

In another embodiment, the address decoder immediately performs the remapping to the upper tier 501 but the buffer 511 holds all remapped memory requests that target the address range 503 until the lower tier 502 is completely flushed 504 into the upper tier 501. Once the flushing 504 is complete, the buffer 511 is released and the memory requests are directed to the upper tier 501.

Upon the excess power state nearing its end, the reverse of the memory tier switching is performed. Namely, the content of the upper tier 501 in region 503 is remapped into the corresponding address space 503 in the lower tier 502. The reverse buffer and address decoding processes described just above can likewise be performed to eventually direct affected memory requests back to the address space 503 in the lower tier 502.

Note that in other embodiments, memory tiering can be achieved with changing memory performance states such as described above with respect to FIG. 4. For example, a first lower power can be effected with one or more DIMMs or other memory modules that are clocked at a first, lower clock frequency. Then, upon excess power being available, these same DIMMs/modules are clocked at a higher clock frequency. This particular approach relies on changing the performance/power of a same memory region and therefore does not require flushing between different memories or unused memory space in the nominal or excess power states.

Although the term “ambient” power has been used to refer to green or low carbon emission energy sources (e.g., wind, solar), the term can be interpreted to mean other low carbon emission energy sources, such as nuclear, fuel cells, etc., that are not necessarily ambient sources of power to the extent such energy sources experience fluctuations in produced energy that can result in availability of excess energy as described at length above.

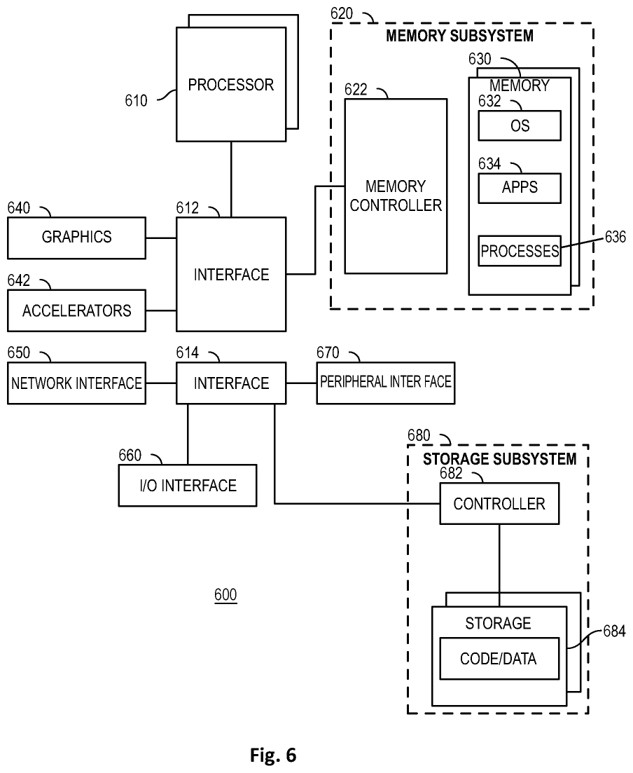

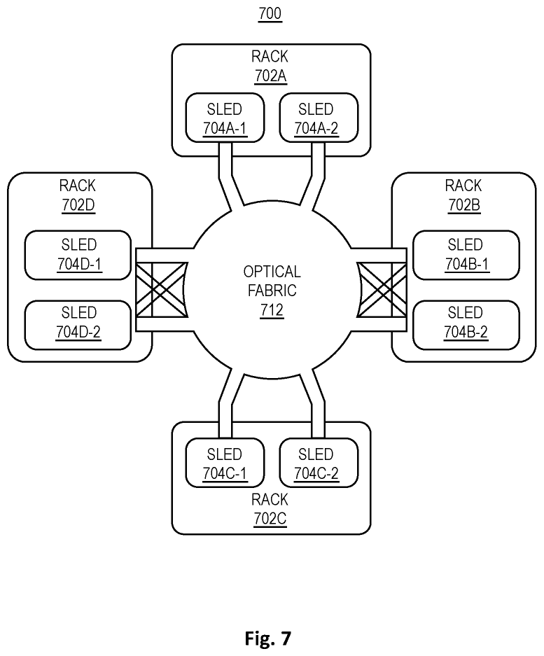

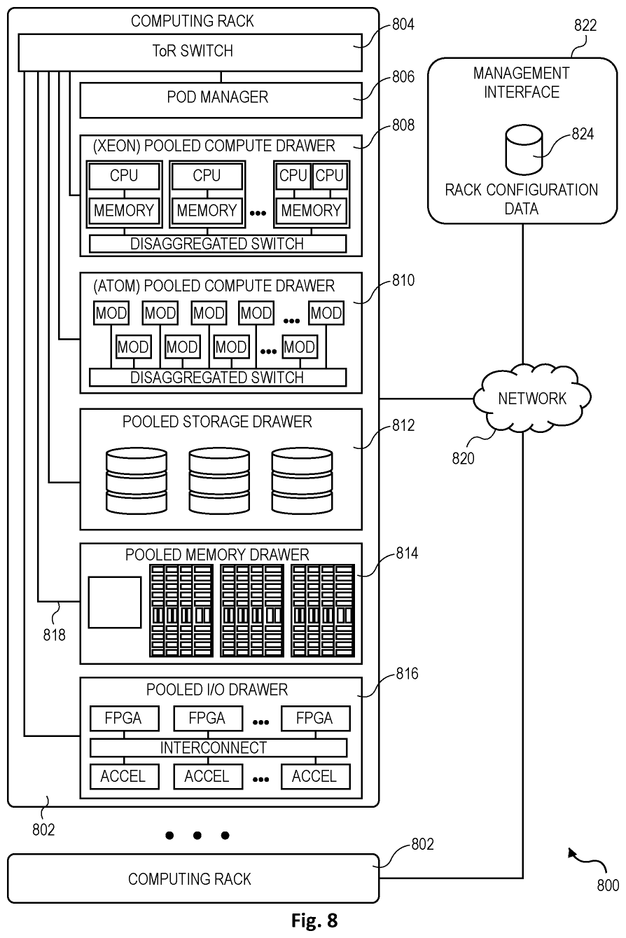

The following discussion concerning FIGS. 6, 7, and 8 are directed to systems, data centers and rack implementations, generally. FIG. 6 generally describes possible features of an electronic system that can be installed in a data center and performs at least some of the processes described above. FIG. 7 describes possible features of a data center that can perform the methodologies described above. FIG. 8 describes possible features of a rack having one or more of the electronic systems of FIG. 6 installed into it.

FIG. 6 depicts an example system. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 642 can provide multiple neural networks, processor cores, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, volatile memory, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software functionality to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version 3, JESD209-3B, August 2013 by JEDEC), LPDDR4) LPDDR version 4, JESD209-4, originally published by JEDEC in August 2014), WI02 (Wide Input/Output version 2, JESD229-2 originally published by JEDEC in August 2014, HBM (High Bandwidth Memory), JESD235, originally published by JEDEC in October 2013, LPDDR5, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 600 can include one or more buses or bus systems between devices, such as a memory bus, a graphics bus, interface buses, or others. Buses or other signal lines can communicatively or electrically couple components together, or both communicatively, and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits in both processor 610 and interface 614.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base, and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall), a SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented as a disaggregated computing system. For example, the system 600 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 6, other types of systems to which the above described invention can be applied and are also partially or wholly described by FIG. 6 are communication systems such as routers, switches, and base stations.

FIG. 7 depicts an example of a data center. Various embodiments can be used in or with the data center of FIG. 7. As shown in FIG. 7, data center 700 may include an optical fabric 712. Optical fabric 712 may generally include a combination of optical signaling media (such as optical cabling) and optical switching infrastructure via which any particular sled in data center 700 can send signals to (and receive signals from) the other sleds in data center 700. However, optical, wireless, and/or electrical signals can be transmitted using fabric 712. The signaling connectivity that optical fabric 712 provides to any given sled may include connectivity both to other sleds in a same rack and sleds in other racks.

Data center 700 includes four racks 702A to 702D and racks 702A to 702D house respective pairs of sleds 704A-1 and 704A-2, 704B-1 and 704B-2, 704C-1 and 704C-2, and 704D-1 and 704D-2. Thus, in this example, data center 700 includes a total of eight sleds. Optical fabric 712 can provide sled signaling connectivity with one or more of the seven other sleds. For example, via optical fabric 712, sled 704A-1 in rack 702A may possess signaling connectivity with sled 704A-2 in rack 702A, as well as the six other sleds 704B-1, 704B-2, 704C-1, 704C-2, 704D-1, and 704D-2 that are distributed among the other racks 702B, 702C, and 702D of data center 700. The embodiments are not limited to this example. For example, fabric 712 can provide optical and/or electrical signaling.

FIG. 8 depicts an environment 800 that includes multiple computing racks 802, each including a Top of Rack (ToR) switch 804, a pod manager 806, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 808, and INTEL® ATOM™ pooled compute drawer 810, a pooled storage drawer 812, a pooled memory drawer 814, and a pooled I/O drawer 816. Each of the pooled system drawers is connected to ToR switch 804 via a high-speed link 818, such as a 40 Gigabit/second (Gb/s) or 100 Gb/s Ethernet link or an 100+Gb/s Silicon Photonics (SiPh) optical link. In one embodiment high-speed link 818 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 800 may be interconnected via their ToR switches 804 (e.g., to a pod-level switch or data center switch), as illustrated by connections to a network 820. In some embodiments, groups of computing racks 802 are managed as separate pods via pod manager(s) 806. In one embodiment, a single pod manager is used to manage all of the racks in the pod. Alternatively, distributed pod managers may be used for pod management operations. RSD environment 800 further includes a management interface 822 that is used to manage various aspects of the RSD environment. This includes managing rack configuration, with corresponding parameters stored as rack configuration data 824.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled, and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. A method, comprising:
performing a), b), and c) below within a data center:
a) recognizing that excess power derived from one or more ambient sources is available;
b) determining allocations of respective portions of the excess power for different units of hardware within the data center; and,
c) determining respective higher performance and higher power operational states for certain functional blocks within the different units of the hardware to utilize the excess power.

2. The method of claim 1 wherein the different units of hardware comprise a server computer within the data center.

3. The method of claim 1 wherein the different units of hardware comprise a semiconductor chip within the data center.

4. The method of claim 3 wherein the functional blocks include a memory system of the semiconductor chip.

5. The method of claim 1 wherein the method further comprises communicating the allocations to the different units of hardware between b) and c) above.

6. The method of claim 1 wherein the determining of the allocations is at least partially performed by software executing within the data center.

7. The method of claim 6 wherein the determining of the respective higher performance and higher power operational states is at least partially performed by firmware executing within the data center.

8. A machine readable storage medium containing program code that when processed by one or more processors causes a method to be performed, the method comprising:
performing a), b), and c) below within a data center:
a) recognizing that excess power derived from one or more ambient sources is available;
b) determining allocations of respective portions of the excess power for different units of hardware within the data center; and,
c) determining respective higher performance and higher power operational states for certain functional blocks within the different units of the hardware to utilize the excess power.

9. The machine readable storage medium of claim 8 wherein the different units of hardware comprise a server computer within the data center.

10. The machine readable storage medium of claim 8 wherein the different units of hardware comprise a semiconductor chip within the data center.

11. The machine readable storage medium of claim 10 wherein the functional blocks include a memory system of the semiconductor chip.

12. The machine readable storage medium of claim 10 wherein the method further comprises communicating the allocations to the different units of hardware between b) and c) above.

13. The machine readable storage medium of claim 8 wherein the determining of the allocations is at least partially performed by software executing within the data center.

14. The machine readable storage medium of claim 13 wherein the determining of the respective higher performance and higher power operational states is at least partially performed by firmware executing within the data center.

15. A data center, comprising:
a) a plurality of computing systems mounted in multiple racks;
b) one or more networks communicatively coupling the plurality of computing systems; and,
c) application software program code and firmware program code stored on one or more machine readable media, the application software program code to cause one or more of the computing systems to perform a first method comprising i) and ii) below:
i) recognizing that excess power derived from one or more ambient sources is available;
ii) determining allocations of respective portions of the excess power for different units of hardware within the data center; and,
the firmware program code to cause one or more processors of the different units of hardware to perform a second method comprising iii) below:
iii) determining a respective higher performance and higher power operational state for a certain functional blocks within the one unit of the hardware to utilize the unit of hardware's allocated portion of excess power.

16. The data center of claim 15 wherein the one unit of hardware is a semiconductor chip within the data center.

17. The data center of claim 16 wherein the certain functional block is a memory system of the semiconductor chip.

18. The data center of claim 16 wherein the first method further comprises communicating the allocations to the different units of hardware after ii) above.

19. The data center of claim 18 wherein the determining of the allocations considers relative importance of software applications executing within the data center.

20. The data center of claim 19 wherein the determining of the respective higher performance and higher power operational state further comprises choosing a particular configuration amongst multiple configuration options.
